(19) United States
(12) Patent Application Publication
(10) Pub. No.: US 2022/0347635 A1
(43) Pub. Date: Nov. 3, 2022

(54) IMPELLER, A DIFFUSER AND AN ARRANGEMENT USING SUCH IMPELLER AND DIFFUSER IN A FLOTATION TANK

(71) Applicant: Metso Outotec Finland Oy, Tampere (FI)

(72) Inventors: James Humphris, Red Lion, PA (US); Björn Nilsson, Västerfärnebo (SE); Max H. Howie, Wellsville, PA (US)

(73) Assignee: Metso Outotec Finland Oy, Tampere (FI)

(21) Appl. No.: 17/243,690

(22) Filed: Apr. 29, 2021

(51) Int. Cl. B01F 7/00; B01F 3/04

(52) U.S. Cl. CPC B01F 7/00241; B01F 3/04539; B01F 2003/04567

(57) ABSTRACT

An impeller and a diffusor is provided which are configured to be used in a flotation tank to enhance mixing of gas and slurry. The impeller comprises two opposing inlet ends and the diffusor comprises two opposing inlet mouths. The impeller is configured, when arranged inside the diffusor, to pump a bi-directional axial flow of slurry into the diffusor. Further, an arrangement using such diffusor and impeller for the use in a flotation tank to enhance mixing of gas and slurry is provided.

### FIELD OF THE INVENTION

The present disclosure relates to an impeller and a diffusor respectively for mixing a gas and a slurry in a flotation tank, an arrangement for the use in a flotation tank to enhance mixing of gas and slurry, and use of such arrangement in a flotation tank.

### BACKGROUND

Froth flotation is a well-known process which is used in the refining of various metals. The purpose is to separate a desired mineral, known as a valuable mineral, from undesired minerals in an ore referred to as gangue. Froth flotation relies on a physical phenomenon of hydrophobicity and selective surface wetting. The term hydrophobicity refers to the property of a molecule to be repelled from a mass of water. A dust in the form of small particles of crushed and milled ore is mixed with water and is wetted by using a wetting agent. The wetting agent, also known as a surfactant, selectively wets exposed surfaces of the valuable mineral in the dust particles. The wetting agent has a molecular structure that causes the formation of a hydrophobic surface to be formed across the wetted surfaces of the valuable mineral. The wetted mixture, referred to as a slurry, is fed to a flotation tank. The slurry is subjected to an agitation and an aeration. During the aeration, the particles having a wetted hydrophobic surface will adhere to the surfaces of air bubbles. The air bubbles together with the adhered particles of valuable mineral will ascend to the surface of the flotation tank in the form of a froth. The froth may be collected from the surface of the flotation tank and be fed for further processing, such as additional flotation processes, or to other types of processes, such as dewatering or even further grinding, whereas the gangue will remain at the bottom of the flotation tank from which it may be collected for further processing.

The aeration and the agitation is typically performed by arranging an impeller, also known as a rotor, and a diffusor, also known as a stator, near the bottom of the flotation tank. The impeller is arranged concentrically inside the diffusor. A flow of air is arranged adjacent the impeller. As the impeller is set to rotate at a high speed in view of the diffusor, a vortex is generated which pumps the slurry into an inlet of the diffuser. The slurry is then emitted from the diffusor in the radial direction via radially extending openings in the diffusor. The aeration is made by adding gas, typically air, via gas outlets in the impeller. Thereby gas bubbles will be formed to which the valuable mineral in the slurry adhere as given above.

Often a number of flotation tanks with this kind of arrangements are arranged one after the other to improve the yield of valuable mineral from the gangue.

The effectiveness of the froth flotation depends on e.g. the rate and amount of bubble production in the slurry. The better froth formation, the better separation of valuable mineral. Another parameter, which in some circumstances may be of relevance is avoidance of agglomerates in the slurry. The less amount of agglomerates, the larger surface area of the individual particles will be exposed to the air bubbles. It should however be noted that agglomerates are not always something that should be avoided. In some situations, agglomerates may even be favorable. One such example is when the particles in the dust are too small to be captured by the bubble individually. Also, if the separation can be improved, the number of flotation tanks, and hence process steps, may be reduced. This has an impact on the overall energy consumption and also installation cost. Also, it has an impact on the yield of valuable mineral from the gangue.

### SUMMARY

It is an objective of the disclosure to provide an improved impeller and an improved diffusor respectively that alone and in combination provide an enhanced mixing process and an improved capacity in the flotation process.

Another objective is to provide an improved impeller and an improved diffusor respectively that provide an improved froth formation by generating an improved pumping action of slurry from the flotation tank, into and through the impeller and diffusor.

Yet another objective is to provide such improved impeller and diffusor that during high-speed rotation in a flotation tank provides an improved aeration of the slurry.

Still another objective is to provide an arrangement for mixing of gas and slurry in a flotation tank that allows an enhanced separation of valuable mineral from the slurry at a reduced energy consumption.

According to a first aspect, these and other objects are achieved in full, or at least partly, by an impeller for mixing a gas and a slurry in a flotation tank, the impeller

comprising:

a first section having a first inlet end and a first outlet end interconnected by a first envelope surface;

a second section having a second inlet end and a second outlet end interconnected by a second envelope surface; and

a middle section having a first end and a second end; the first and second ends being interconnected by a side wall extending along a rotation axis of the impeller; wherein

the first outlet end of the first section is connected to the first end of the middle section, and the second outlet end of the second section is connected to the second end of the middle section; and wherein

the side wall of the middle section comprises at least one gas outlet configured to communicate with a gas supply.

Accordingly, an impeller is provided which has two opposing inlet ends, whereby the impeller during a high-speed rotation thereof will create two vortexes that together pump slurry towards the middle section from two opposing directions. As the two flows of slurry reach the middle section, the slurry will be subjected to a flow of gas via the at least one gas outlet that is arranged in the side wall of the middle section.

The overall efficiency in the process of separation by flotation relies on the quality of the froth. The faster the individual particles containing a valuable mineral can be subjected to a sufficient amount of gas bubbles for them to ascend towards the upper end of the flotation tank, the better. By the new design of the impeller which generates vortexes from two opposing directions, a faster and higher throughput of fresh particulate matter through the impeller is provided and also more particulate matter over time will be subjected to the gas flow. Thereby the likelihood that the sufficient amount of gas bubbles will adhere to the particles containing valuable mineral and hence be caught in the froth for removal from the flotation tank is increased.

Further, by the at least one gas outlet being arranged in the middle section between the first and second sections of the impeller, the slurry leaving the impeller in the radial direction thereof will be arranged in something that may be seen as a virtual three-layered sandwich structure with a first layer of slurry, an intermediate gas layer and a second layer of slurry. Trials have shown the surprising result of a very efficient aeration of valuable minerals as the virtual three-layered sandwich structure with a high radial speed meets the diffusor blades in the static diffusor where the sandwich structure will be dissolved. Not only will bubbles form which intermix with the particulate matter in the slurry, but also a very efficient breaking-up of any agglomerates has been shown. It is a well-known fact that the density of particulate matter in a slurry will be different depending on where in the flotation tank the density is measured. Due to gravity, the density and amount of agglomerates will always be higher closer to the bottom of the flotation tank than closer to the top of the flotation tank. Since the impeller is configured to pump slurry from two different levels in the flotation tank, the virtual sandwich structure will contain a better mixture of particulate matter in all degrees of aeration and a wider spread in size, which is a likely driver for the improved frothing and hence faster separation that has been seen to result.

The side wall in the middle section which interconnects the first and second ends of the impeller may have a straight or curved extension.

The first and/or the second envelope surface may each have a concave shape as seen in view of the rotation axis of the impeller. By the concave shape, the slurry which is pumped by the impeller during high-speed rotation thereof will be better guided in the radial direction towards the gas flow which is emitted by the at least one gas outlet in the middle section.

The first envelope surface may comprise a plurality of vanes having an extension in a direction between the first inlet end and the first outlet end. Alternatively, or in addition, the second envelope surface may comprise a plurality of vanes having an extension in a direction between the second inlet end and the second outlet end. The provision of the vanes enhances the pumping of slurry towards and past the impeller. The skilled person realizes that the vanes may be designed in a number of ways. The vanes may by way of example extend in the strict radial direction of the impeller or have a helical extension. Also, the vanes may extend along the full envelope surface or only along a portion of the respective envelope surface. Additionally, the vanes may have the same or different design as seen on the first and second envelope surfaces.

The vanes of the first envelope surface may have an outer edge facing away from the first envelope surface, said outer edge having a concave shape as seen in view of the rotation axis of the impeller. Additionally, or as an alternative embodiment, the vanes of the second envelope surface may have an outer edge facing away from the second envelope surface, said outer edge having a concave shape as seen in view of the rotation axis of the impeller. The concave shape of the outer edges of the first and second envelope surfaces may have a curvature which is complementary to radially opposing surfaces of the diffusor in which the impeller is configured to be arranged.

The vanes of the second envelope surface may have an inner edge facing the rotation axis of the impeller, and an outer edge facing away from the rotation axis of the impeller, wherein the inner and outer edges merge in a tip, wherein said tip is radially displaced in view of the rotation axis of the impeller. The plurality of vanes of the second envelope surface thereby define a dome-shape compartment which encircles the rotation axis of the impeller. This dome-shaped compartment facilitates the guiding of slurry towards the impeller and in the radial direction along the second envelope surface where it will come in contact with the gas emitted from the at least one gas outlet in the middle section.

A vane in the first section of the impeller and a vane in the second section of the impeller may form a pair of vanes, and radially outer edges of the vanes in each pair may together with the side wall of the middle section of the impeller have an extension substantially in parallel with the rotation axis of the impeller. Thereby, the slurry will be efficiently guided towards the at least one gas outlet which further enhances the aeration of the slurry and hence the adhesion of particles of valuable mineral to gas bubbles.

The middle section of the impeller may further comprise a circumferentially extending groove communicating with the at least one gas outlet. The groove provides a pressure drop in the gas flow which leaves the at last one gas outlet. The pressure drop increases the gas volume and hence the contact between gas and particulate matter in the slurry. Thereby the aeration of the particulate matter may be further enhanced.

The groove may comprise a plurality of radially extending fins. The fins have shown to further enhance the aeration of the particulate matter in the slurry.

The plurality of fins may have an extension in the radial direction of the groove which is smaller than a radial depth of the groove, and the plurality of fins may have an outer edge portion which is aligned with the side wall of the middle section.

According to another aspect, these and other objects are also achieved in full, or at least in part by a diffusor for mixing a gas and a slurry in a flotation tank.

The diffusor comprises:

a first annular section;

a second annular section; and

a middle section comprising a plurality diffusor blades extending along a longitudinal center line of the diffusor, and wherein the first annular section and the second annular section are connected on opposite sides of the middle section as seen along the longitudinal center line of the diffusor, wherein

the first annular section comprises a funnel shaped inlet end forming a first inlet mouth of the diffusor; and

the second annular section comprises a funnel shaped inlet end forming a second inlet mouth of the diffusor.

Accordingly, a diffusor is provided which has two inlet mouths, one on each side of the middle section. This means that that an impeller, and especially an impeller of the type previously discussed, which is rotatably arranged inside the diffusor, will during a high-speed rotation pump slurry into the diffusor from two opposing directions, one from the bottom of the flotation tank and one from the top of the flotation tank. This principle has been described above and is included here by reference. The thus pumped and aerated flow of slurry will exit the diffusor via radial openings which are formed between the plurality of radially and longitudinally extending diffusor blades. During the passage through the diffusor blades, any agglomerates will be crushed into smaller agglomerates or even better into separate particles while hitting the diffusor blades. Also, the above described virtual three-layered sandwich of slurry and gas will be efficiently separated and dissolved, thereby enhancing the aeration of the particulate matter and hence promote that the valuable minerals adhere to the bubbles. The formation of froth and also the quality of the froth will be enhanced and thereby the overall efficiency in the process of separation by frothing will be improved.

The respective funnel shaped inlet ends which form the first and second inlet mouths of the diffusor contribute to the guiding of the opposing vortexes of slurry that result from a high-speed rotation of an impeller inside the diffusor; and which vortexes pump the slurry in the axial direction into the diffusor.

The first annular section may further comprise a funnel shaped outlet end, and wherein a narrow end of the funnel shaped inlet end merges with a narrow end of the funnel shaped outlet end, and the middle section interconnects with a wide end of the funnel shaped outlet end; and

the second annular section may further comprise a funnel shaped outlet end, and wherein a narrow end of the funnel shaped inlet end merges with a narrow end of the funnel shaped outlet end, and the middle section interconnects with a wide end of the funnel shaped outlet end.

The respective funnel shaped outlet ends of the diffusor contribute to the guiding of the opposing vortexes of slurry that result from a high-speed rotation of an impeller inside the diffusor. More precisely, the funnel shaped outlet ends facilitates a redirection of the axial flow into a radial flow inside the diffusor towards the radial openings which are formed between the plurality of radially and longitudinally extending diffusor blades.

The funnel shaped inlet and outlet ends of the first and second annular sections may each have a convex envelope surface as seen in view of the longitudinal center line of the diffusor.

The convex envelope surface of the respective funnel shaped inlet and/or outlet contributes to the guiding of the vortex of slurry that results from a high-speed rotation of an impeller inside the diffusor; and which vortex pumps the slurry into the diffusor. Not only does it contribute to the slurry entering the diffusor in the axial direction, but also to guiding of the slurry in the radial direction towards the radial openings which are formed between the plurality of radially and longitudinally extending diffusor blades. The convex envelope surfaces do accordingly contribute to an efficient guiding of slurry into and out of the diffusor without causing any undue turbulence and hence energy loss over any sharp edges.

The first and second inlet mouths may each have a radius being smaller than an inner most radius of the plurality of diffusor blades. The radius of the first and second inlet mouths may be the same or be different. In one preferred embodiment the radius of the second inlet mouth is smaller than the radius of the first inlet mouth.

The second annular section and the middle section may each have a length along the longitudinal center line of the diffusor, and the length of the second annular section may exceed or correspond to the length of the middle section.

The first annular section and the middle section may each have a length along the longitudinal center line of the diffusor, and the length of the first annular section may be smaller than the length of the middle section.

The first annular section and the second annular section may each have a length along the longitudinal center line of the diffusor, and the length of the first annular section may be smaller than the length of the second annular section.

By the different lengths, the centrifugal force in the vortex created in the first and second annular sections, and hence the pumping effect as seen in the two opposite directions will be different. The density of the slurry will due to gravity be higher in the lower portion of the flotation tank than in the upper portion of the flotation tank. This means that the energy which is required to pump slurry from the lower portion of the flotation tank into the diffusor is higher than the energy that is required to pump slurry into the diffusor from the upper portion of the flotation tank. By providing the first and second annular sections with different lengths, one and the same impeller to be arranged inside the diffusor may generate two vortexes of different strengths. Especially, by making the second annular section longer than the first annular section, a stronger vortex may be generated in the lower portion of the flotation tank and hence a stronger pumping force.

The radius of the second inlet mouth of the diffusor may be smaller than the radius of the first inlet mouth of the diffusor. This difference in radius has a positive impact on the formation of vortexes of different strengths.

According to yet another aspect, these and other objects are also achieved, in full or at least in part, by an arrangement for the use in a flotation tank to enhance mixing of gas and slurry. The arrangement comprises an impeller with the above discussed features, and a diffusor with the above discussed features, and in which apparatus, the impeller is configured to be rotatably and coaxially received inside the diffusor.

In summary, an arrangement is provided which uses an improved impeller and diffusor respectively. The operation principle of the inventive impeller and the inventive diffusor respectively has been thoroughly discussed both in the context of standalone units but also in combination. These arguments are equally applicable to an arrangement where such impeller is arranged inside such diffusor.

The impeller is designed to generate two vortexes which act in two opposite axial directions, whereby the slurry can be pumped into the diffusor from two opposing directions. To account for this bi-directional pumping action, the inventive diffusor is provided with two opposing funnel-shaped inlet mouths. Not only are the two inlet mouths funnel shaped, but also the respective funnel outlets into the middle section of the diffusor where the substantial part of the impeller is arranged. Further, in each end of the diffusor, the envelope surface of the funnel portion that forms the inlet and the envelope surface of the funnel portion that forms the outlet merge along a waist portion that has a radius which is smaller than the inner radius of the diffusor blades. The inventive diffusor is thereby designed to guide the incoming flow of slurry in the axial direction and then re-direct the flow into the radial direction with a reduced loss of energy. The slurry will thereby meet the gas flow with a higher energy and also meet the diffusor blades with a higher energy, which has shown to result in a more efficient breaking-up of agglomerates into smaller fractions and a more efficient froth formation by beating the gas flow into bubbles which may adhere to particles of valuable mineral.

The outer edge of the vanes on the first section of the impeller may have a shape being substantially complementary to a portion of the funnel shaped outlet end of the first annular section of the diffusor; and/or

the outer edge of the vanes on the second section of the impeller may have a shape being substantially complementary to a portion of the funnel shaped outlet end of the second annular section of the diffusor.

By the substantially complementary shape of the outer edges of the vanes of the impeller and the funnels shaped outlet ends of the diffusor, something that may be seen as a virtual three-layered sandwich structure with a first layer of slurry, an intermediate gas layer and a second layer of slurry will be formed as the slurry leaves the middle portion of the impeller and enters the radial openings which are formed between the plurality of radially and longitudinally extending diffusor blades. During the passage through the diffusor blades, agglomerates may be crushed into smaller agglomerates and in some cases even into separate particles while hitting the diffusor blades. Also, the virtual three-layered sandwich of slurry and gas will be efficiently separated and dissolved, thereby enhancing the aeration of the particulate matter and hence promote that the valuable minerals adhere to the bubbles. The formation of froth and also the quality of the froth will be enhanced and thereby the overall efficiency in the process of separation by frothing will be improved.

The thus formed gap between the vanes and the funnel shaped outlet ends of the diffusor may be constant, or more preferred narrow in the radially outward direction.

A radially extending gap may be formed between the side wall of the middle section of the impeller and the plurality of diffusor blades of the diffusor.

According to still another aspect, the disclosure refers to the use of an arrangement with the features given above in a flotation tank to enhance mixing of gas and slurry.

The operation principle of the impeller and the diffusor respectively has been thoroughly discussed above, both in the context of standalone items but also in combination. These arguments are equally applicable to the use of such arrangement where such impeller is arranged inside such diffusor.

Other objectives, features and advantages will appear from the following detailed disclosure, from the attached claims, as well as from the drawings. It is noted that the invention relates to all possible combinations of features.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise.

As used herein, the term “comprising” and variations of that term are not intended to exclude other additives, components, integers or steps.

As used herein, the expression “adapted to be received” in for example the phrase: “a first element adapted to be received in a through hole”, means that at least a part of said first element is adapted to be spatially positioned within the through hole.

### BRIEF DESCRIPTION OF THE DRAWINGS

The disclosure will be described in more detail with reference to the appended schematic drawings, which show an example of a presently preferred embodiment of the disclosure.

FIG. 1 shows a schematic cross section of an arrangement according to one embodiment as arranged in a flotation tank.

FIG. 2 discloses a perspective view of one embodiment of the impeller as seen from its first end.

FIG. 3 discloses a perspective view of one embodiment of the impeller as seen from its second end.

FIG. 4 discloses a schematic cross section of the diffusor.

FIG. 5 discloses one embodiment of a diffusor.

FIG. 6 discloses a schematic cross section of an arrangement and the air supply.

FIG. 7 discloses a schematic cross section of an arrangement and the flow of slurry therethrough.

FIG. 8 discloses an alternative embodiment of an impeller.

### DETAILED DESCRIPTION

The present disclosure will now be described more fully hereinafter with reference to the accompanying drawings, in which currently preferred embodiments of the disclosure are shown. The present disclosure may, however, be embodied in many different forms and should not be construed as limited to the embodiments set forth herein; rather, these embodiments are provided for thoroughness and completeness, and to fully convey the scope of the disclosure to the skilled addressee. Like reference characters refer to like elements throughout.

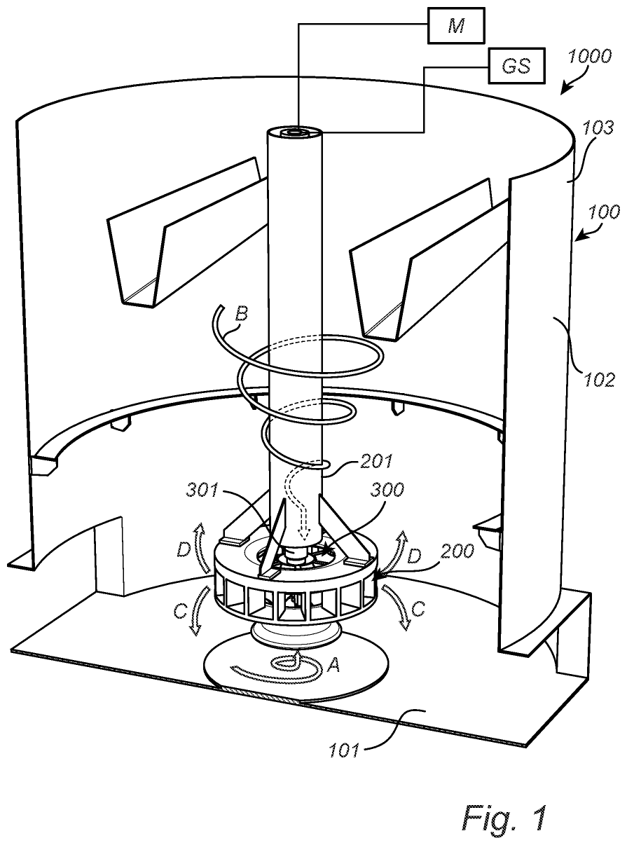

Starting with FIG. 1, a schematic cross section of an arrangement 1000 according to one embodiment is disclosed as being arranged in a flotation tank 100. A flotation tank with the arrangement arranged therein is often known in the field as a flotation cell or a part of a flotation cell. To facilitate understanding, only a portion of the flotation tank 100 is disclosed. The flotation tank 100 comprises, a bottom wall 101 and a vertically extending side wall 102. The side wall 102 is preferably cylindrical. The upper end 103 of the flotation tank 100 may be either open or closed. The flotation tank 100 is configured to contain a non-disclosed mixture of a dust of small particles of crushed ore, also known in the art as gangue, liquid and a wetting agent.

The arrangement 1000 further comprises a diffusor 200. The diffusor 200 is fixedly supported in the flotation tank 100 by a vertically extending support 201. The diffusor 200 may hence be seen as a stator. The diffusor 200 is preferably arranged close to the bottom wall 101 of the flotation tank 100. The skilled person realises that the diffusor 200 may be supported in a number of ways with remained function. By way of example, the diffusor may, with remained function, be supported by a support which extends from the bottom wall of the flotation tank.

The diffusor 200 houses a rotatable impeller 300. The impeller 300 which may be seen as a rotor is rotatably supported by a hollow shaft 301 which is concentrically arranged inside the support 201 of the diffusor 200. The hollow shaft 301 is connected to a gas supply GS and to a motor M. The motor M is configured to rotate the impeller 300 at a high speed inside the diffusor 200 in a manner well known to the skilled person. The gas supply GS is configured to supply gas, such as air, to the impeller 300 via the hollow shaft 301 to thereby aerate the slurry of dust and liquid which is formed as the impeller 300 rotates.

The arrangement according to the present disclosure differs from prior art arrangements in that the impeller 300 and the diffusor 200 are designed so that the high-speed rotation of the inventive impeller 300 generates two opposing vortexes, see arrow A and B that cause a bi-directional pumping of slurry into the diffusor 200 in the axial direction. The flow of slurry is redirected inside the diffusor 200 and leaves the same in the radial direction, see arrows C and D. Thereby a circulation flow of slurry through the impeller 300 and the diffusor is generated.

As the circulation continues, a non-disclosed froth is formed which contains separated particles of valuable minerals that have adhered to gas bubbles. Due to the lower density of the froth, it will ascend to the top end 103 of the flotation tank 100 from where it may be removed for further processing. This whole process of separation of valuable minerals by means of frothing is well known in the art and is not further discussed.

Before going into the details of the embodiments, the terms “first” and “second” will be used throughout the description and the claims. Unless nothing else is given, the term “first” refers to the upper end/portion of the specific component as seen in a condition when the component is mounted in the floatation tank. Correspondingly, the term “second” refers to the lower end/portion of the specific component as seen in a condition when the component is mounted in the floatation tank. The impeller and diffusor of the arrangement are typically configured to be arranged to extend in the vertical direction along a vertically extending rotation axis. This is also the orientation disclosed in the drawings.

Further, the term “funnel” will be used. The term “funnel” is to be understood as an axially extending hollow member having a circular cross section, a wide open end, a narrow open end and an envelope surface extending between and interconnecting the two open ends.

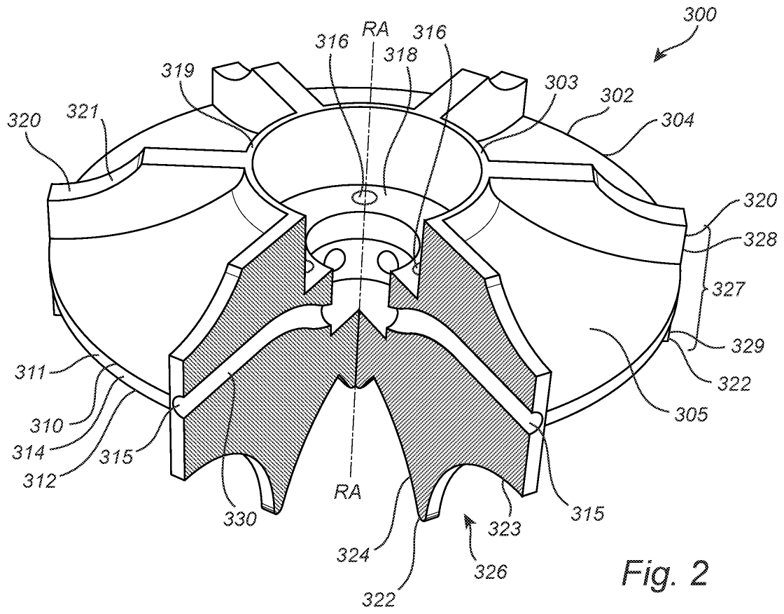

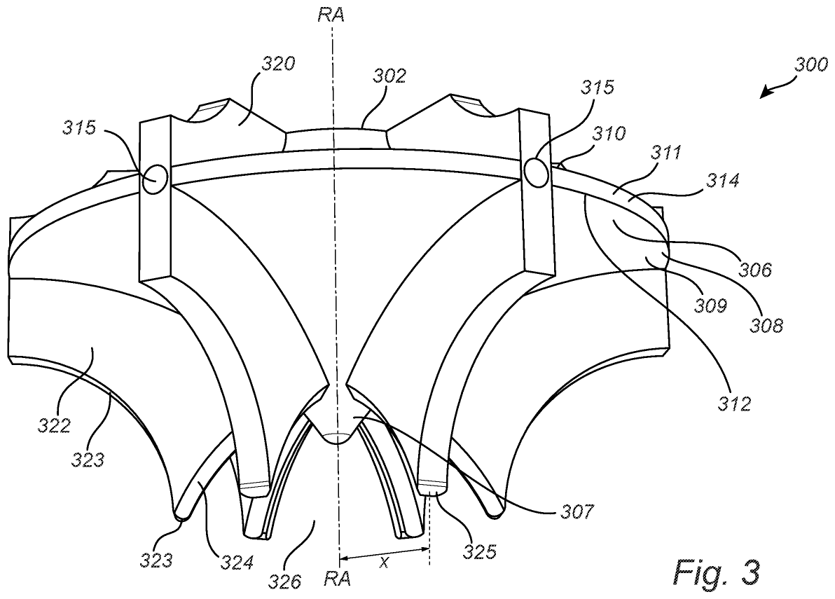

Now turning to FIGS. 2 and 3, one embodiment of the impeller 300 according to one embodiment will be described. FIG. 2 discloses a perspective view from the top of the impeller and has been provided with a schematic cut-out extending through two adjacent vanes to better illustrate the gas channels. FIG. 3 discloses a perspective view from below.

The impeller 300 comprises a first section 302 having a first inlet end 303 and a first outlet end 304. The first inlet and outlet ends 303, 304 are interconnected by a first envelope surface 305. Further, the impeller 300 comprises a second section 306 having a second inlet end 307 and a second outlet end 308. The second inlet and outlet ends 307, 308 are interconnected by a second envelope surface 309.

The first outlet end 304 of the first section 302 is connected to a first end 310 of a middle section 311, and the second outlet end 308 of the second section 306 is connected to a second end 312 of the middle section 311. The first and second ends 310, 312 of the middle section 311 are interconnected by a side wall 314. The side wall 314 extends along a rotation axis RA of the impeller 300. The side wall 314 may be straight or curved.

The side wall 314 of the middle section 311 is exemplified as comprising a plurality of gas outlets 315. Each gas outlet 315 is configured to communicate with the gas supply GS disclosed in FIG. 1 via internal channels 330 in the impeller 300. The skilled person realizes that it may be sufficient with one single gas outlet 315 which is connected to the gas supply. The internal gas channels 330 are configured to communicate with the gas supply GS via the hollow shaft 301, see FIG. 1. A top wall 318 of the impeller 300 comprises a plurality of holes 316 configured to be used for mounting of the impeller 300 to the hollow shaft 301, see FIG. 1. The top wall 318 is surrounded by a peripheral neck 319.

The first and the second envelope surfaces 305, 309 do each have a concave shape as seen in view of the rotation axis RA of the impeller 300. The first envelope surface 305 extends from the first end 310 of the middle section 311 to a free edge of the peripheral neck 319. The second envelope surfaces 309 extends from the second end 312 of the middle section 311 and forms a downwardly oriented cone which is concentric with the rotation axis RA of the impeller 300.

The first envelope surface 305 comprises a plurality of vanes 320 having an extension in a direction between the first inlet end 303 and the first outlet end 304 of the first section 302. The vanes 320 are disclosed as having a straight extension in the radial direction. The skilled person realizes that the vanes 320 with remained function may have other extensions, such as a non-disclosed helical extension. Also, the vanes 320 may extend along the full axial extension of the first envelope surface 305 or only along a portion thereof.

The vanes 320 of the first envelope surface 305 have an outer edge 321 facing away from the first envelope surface 305. The outer edge 321 has a concave shape as seen in view of the rotation axis RA of the impeller 300.

The concave shape of the outer edge 321 of the vanes 320 on the first envelope surface 305 may, as will be further described below, have a curvature which is complementary to a radially opposing surface of the diffusor 200 in which the impeller 300 is configured to be arranged.

The second envelope surface 309 comprises a plurality of vanes 322 having an extension in a direction between the second inlet end 307 and the second outlet end 308 of the second section 306. The vanes 322 are disclosed as having a straight extension in the radial direction. The skilled person realizes that the vanes 322 with remained function may have other extensions, such as a non-disclosed helical extension. The vanes 322 may extend along the full axial extension of the second envelope surface 309 or only along a portion thereof.

The vanes 322 of the second envelope surface 309 may have an outer edge 323 facing away from the second envelope surface 309. The outer edge 323 has a concave shape as seen in view of the rotation axis RA of the impeller 300.

The concave shape of the outer edge 323 of the vanes 322 on the second envelope surface 309 may, as will be described below, have a curvature which is complementary to a radially opposing surface of the diffusor 200 in which the impeller 300 is configured to be arranged.

As is best seen in FIG. 3, the vanes 322 of the second envelope surface 309 have an inner edge 324 facing the rotation axis RA of the impeller 300, and the outer edge 323 facing away from the rotation axis RA. The inner edges 324 have concave extension in view of the rotation axis RA of the impeller 300. The outer and inner edges 323 and 324 merges in a tip 325, which is radially displaced X in view of the rotation axis RA of the impeller 300. The plurality of vanes 322 on the second envelope surface 309 thereby defines a dome-shape compartment 326 which encircles the rotation axis RA of the impeller 300. This dome-shaped compartment facilitates the guiding of slurry towards the impeller 300 and in the radial direction along the second envelope surface 309 where it will come in contact with the gas emitted from the plurality of gas outlets 315 in the middle section 311.

The vanes 320, 322 may have the same or different design on the first and second envelope surfaces 305, 309.

Now turning to FIG. 2, a vane 320 in the first section 302 and a vane 322 in the second section 306 do together form a pair 327 of vanes. Radially outer edges 328, 329 of the vanes 320, 322 in each pair 327 do together with the side wall 314 of the middle section 311 have an extension substantially in parallel with the rotation axis RA of the impeller 300. This has been seen as resulting in the effect that the slurry, during a high-speed rotation of the impeller 300, will be efficiently guided towards the gas outlets 315, whereby the aeration of the slurry and hence the contact between particles of valuable mineral and gas bubbles will be enhanced during operation of the impeller 300.

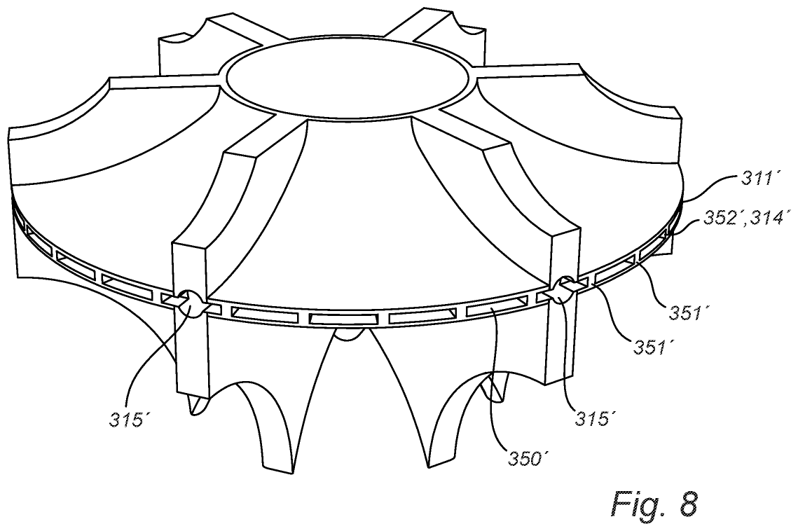

Now turning to FIG. 8, and alternative embodiment of the impeller 300′ is disclosed. The impeller has the overall same design as that disclosed in FIGS. 2 and 3 with the exception for the middle section 311′.

In the alternative embodiment, the middle section 311′ is provided with a circumferentially extending groove 350′ which communicates with a plurality of gas outlets 315′. The groove 350′ provides a pressure drop in the gas flow leaving the gas outlets 315′ which increases the gas volume and hence the contact between gas and particulate matter in the slurry in an area in and around said groove 350′. Thereby the aeration of the particulate matter may be further enhanced. The skilled person realizes that although a plurality of gas outlets is disclosed, it may be sufficient with one gas outlet only.

The groove 350′ may comprise a plurality of optional radially extending fins 351′. By the fins 351′ the aeration of the particulate matter in the slurry may be further enhanced.

The plurality of fins 351′ may have an extension in the radial direction of the groove 350′ which is smaller than a radial depth of the groove 350′. Further, the plurality of fins 351′ may have an outer edge portion 352′ which is aligned with the side wall 314′ of the middle section 311′

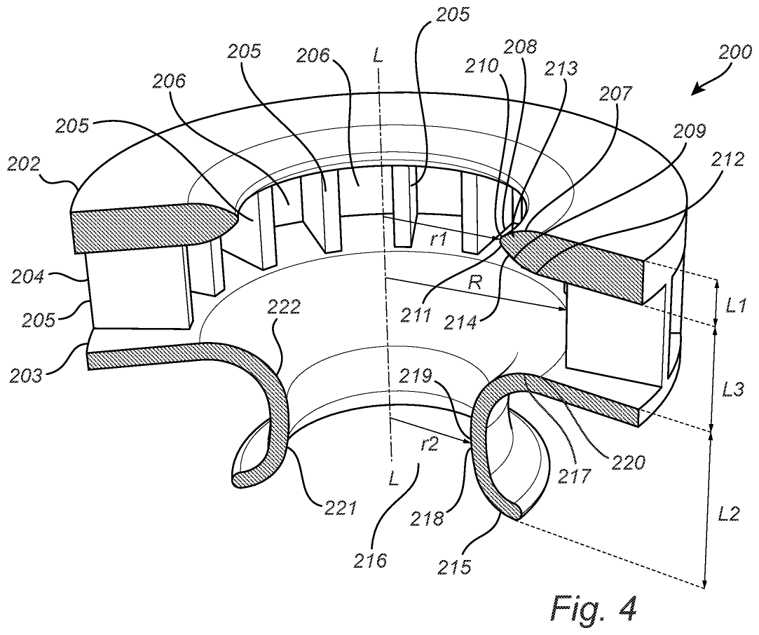

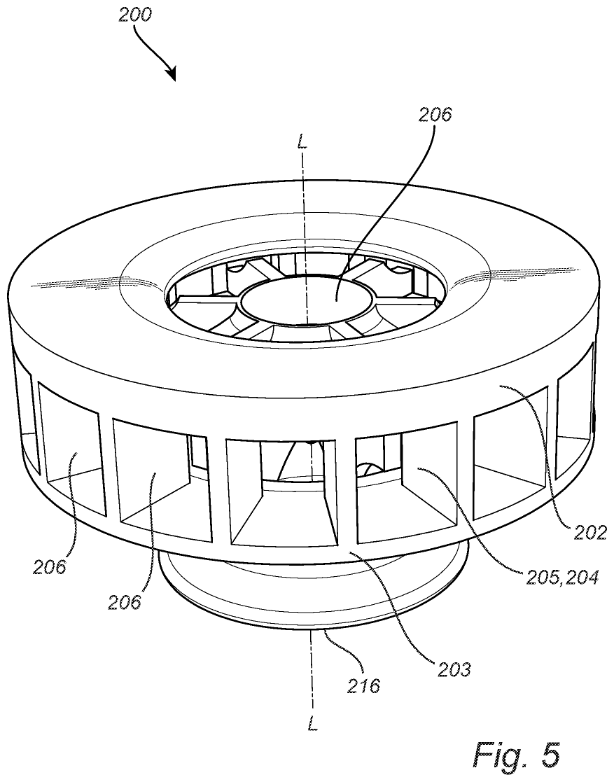

Now turning to FIGS. 4 and 5, one embodiment of a diffusor 200 is disclosed. The diffusor 200 has an overall rotation symmetrical design and is configured to concentrically encircle the impeller 300. FIG. 4 discloses a cross section of the diffusor 200 to better illustrate its interior design. FIG. 5 discloses a perspective view of the diffusor 200.

The diffusor 200 comprises a first annular section 202, a second annular section 203, and a middle section 204 which extends between and interconnects the first and second sections 202, 203. Thus, the first annular section 202 and the second annular section 203 are connected on opposite sides of the middle section 204. The middle section 204 comprises a plurality of radially and longitudinally extending diffusor blades 205 extending along a longitudinal center line L of the diffusor 200. Radially and axially extending gaps 206 are formed between the plurality of diffusor blades 205.

As is best seen in FIG. 4, the first annular section 202 comprises a funnel shaped inlet end 207 which forms a first inlet mouth 208 of the diffusor 200. The first annular section 202 further comprises a funnel shaped outlet end 209. A funnel has, per definition a wide open end, a narrow open end and an envelope surface extending between the two ends. The narrow end 210 of the funnel shaped inlet end 207 merges with the narrow end 211 of the funnel shaped outlet end 209. Further, the middle section 204 interconnects with the wide end 212 of the funnel shaped outlet end 209.

The envelope surfaces 213, 214 of the funnel shaped inlet end 207 and the funnel shaped outlet end 209 respectively are convex as seen in view of the longitudinal center line L of the diffusor 200.

Further, the first inlet mouth 208 has a radius r1 which is smaller than an inner most radius R of the plurality of diffusor blades 205.

Correspondingly, the second annular section 203 comprises a funnel shaped inlet end 215 which forms a second inlet mouth 216 of the diffusor 200. The second annular section 203 further comprises a funnel shaped outlet end 217. The narrow end 218 of the funnel shaped inlet end 215 merges with the narrow end 219 of the funnel shaped outlet end 217. Further, the middle section 204 interconnects with the wide end 220 of the funnel shaped outlet end 217.

The envelope surface 221, 222 of the funnel shaped inlet end 215 and the funnel shaped outlet end 217 respectively is convex as seen in view of the longitudinal center line L of the diffusor 200.

Further, the second inlet mouth 216 has a radius r2 which is smaller than the inner most radius R of the plurality of diffusor blades 205. The radius r2 of the second inlet mouth 216 of the diffusor 200 may be smaller than the radius r1 of the first inlet mouth 208 of the diffusor 200.

The first annular section 202, the second annular section 203 and the middle section 204 do each have a length along the longitudinal center line L of the diffusor 200. The length L1 of the first annular section 202 may be smaller than the length L3 of the middle section 204. The length L2 of the second annular section 203 may exceed or correspond to the length L3 of the middle section. Also, the length L1 of the first annular section 202 may be smaller than the length L2 of the second annular section 203.

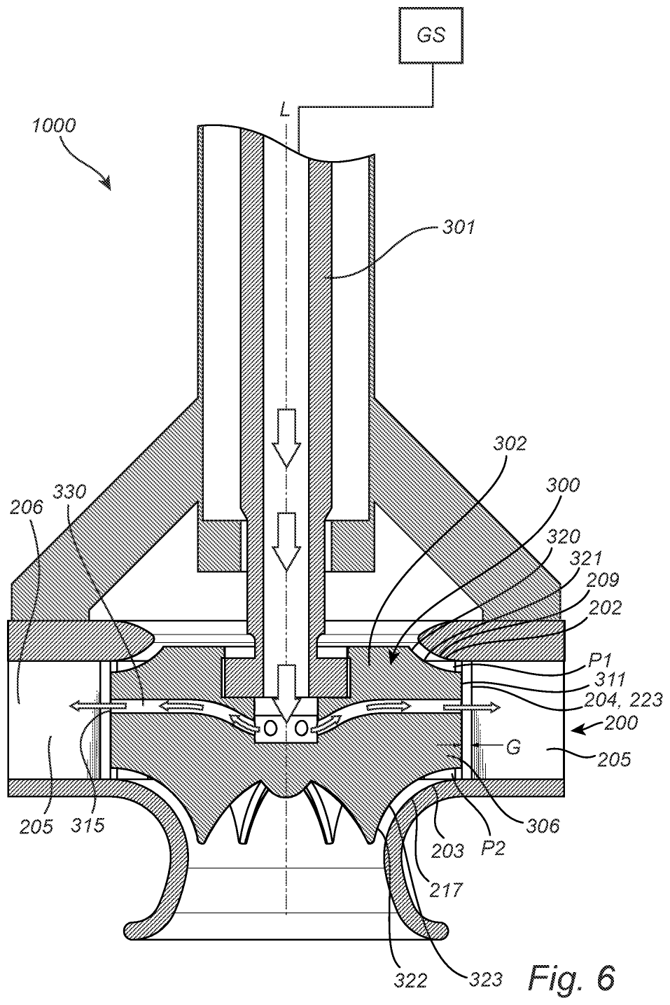

Now turning to FIG. 6, a first schematic cross section of the arrangement 1000 is disclosed. The cross section is taken through two opposing gaps 206 that are formed between two subsequent diffusor blades 205 of the plurality of circumferentially distributed diffusor blades in the diffusor 200. To facilitate understanding, the flotation tank has been omitted and only a portion of the hollow shaft 301 that is configured to support the impeller 300 is disclosed.

The diffusor 200 has an overall rotation symmetrical design and encircles the impeller 300 concentrically along the longitudinal center line L. The middle section 311 of the impeller 300 is substantially contained in an area which is defined by the longitudinal extension of the middle section 204 of the diffusor 200. The vanes 320, 322 on the first and second sides of the impeller 300 are substantially contained in areas which are defined by the longitudinal extensions of the two opposing funnel shaped outlet ends 209, 217 of the diffusor 200.

The impeller 300 is rotatably and coaxially received inside the diffusor 200. The outer edges 321 of the vanes 320 on the first section 302 of the impeller 300 have a shape which is substantially complementary to a portion of the funnel shaped outlet end 209 of the first annular section 202 of the diffusor 200. Also, the outer edge 323 of the vanes 322 on the second section 306 of the impeller 300 have a shape which is substantially complementary to a portion of the funnel shaped outlet end 217 of the second annular section 203 of the diffusor 200.

A first passage P1 is formed in the interspace between the vanes 320 on the first section 302 of the impeller 300 and the funnel shaped outlet end 209 of the first annular section 202 of the diffusor 200. Correspondingly, a second passage P2 is formed between the vanes 322 on the second section 306 of the impeller 300 and the funnel shaped outlet end 217 of the second annular section 203 of the diffusor 200. The first and second passages P1, P2 merge with a radially extending gap G which is formed between the side wall 314 of the middle section 311 of the impeller 300 and an inner edge 223 of the plurality of diffusor blades 205.

The hollow shaft 301 is connected to the first end of the impeller 300. The opposing end of the hollow shaft 301 is connected to a gas supply GS. The hollow shaft 301 is connected to the impeller 300 so that the gas-supply GS may feed gas from the gas supply GS, via the interior of the hollow shaft 301 and into the impeller 300 from which is distributed in the radial direction via the gas channels 330 to the plurality of gas outlets 315 which are distributed along the perimeter of the middle section 311 of the impeller 300. The gas is released into the radially extending gap G. As given above, it is possible with one gas outlet only.

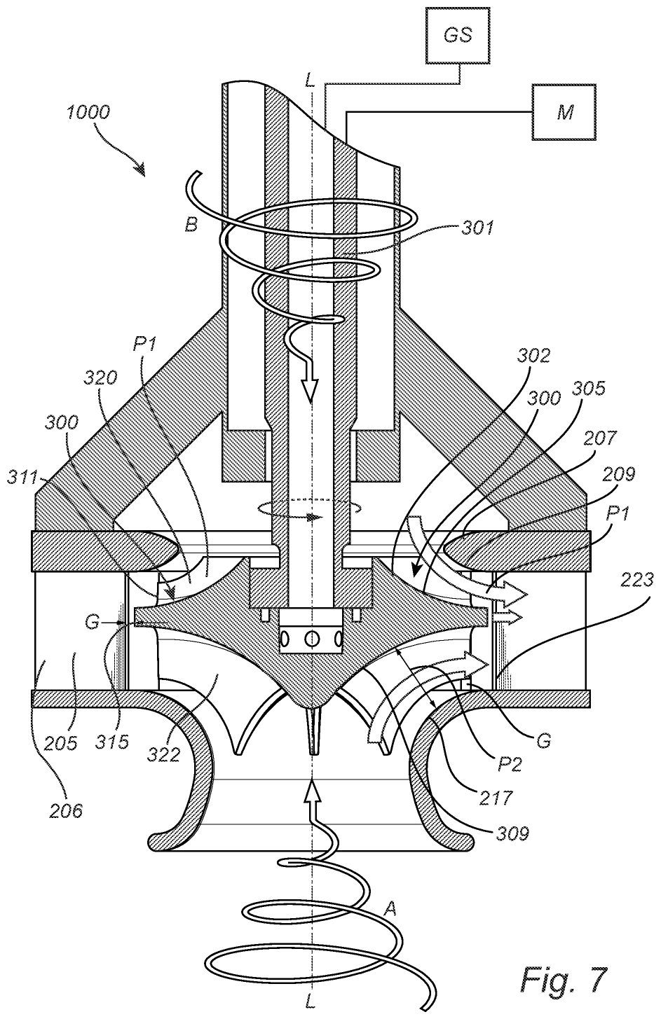

Now turning to FIG. 7, a second schematic cross section of the arrangement 1000 is disclosed. The cross section is taken through the interspace between two subsequent pairs of vanes 320, 322 of the impeller 300 and between two opposing gaps 206 that are formed between two subsequent diffusor blades 205 of the plurality of circumferentially distributed diffusor blades in the diffusor 200. To facilitate understanding, the flotation tank has been omitted and only a portion of the hollow shaft 301 that is configured to support the impeller 300 is disclosed.

Although the process to be exemplified below constitutes a batch process, the skilled person realizes that the process equally well may be run as a continuous process. As the impeller 300 is set to rotate by the motor M around the longitudinal center line L, the slurry comprising liquid and particulate matter will be initially agitated to form a slurry, and as the speed is increased, two vortexes A, B are formed which pumps the slurry into the diffusor 200 through the two opposing first and second funnel shaped inlet ends 207, 209. Thus, the two vortexes are oriented in opposite directions towards the interior of the diffusor 200. The slurry will be forced by the centrifugal force in the radial direction, through the gaps P1 and P2 which are formed between the vanes 320, 322 and the first and the second funnel shaped outlet ends 209, 217 and into the radial gap G between the side wall 314 of the middle section 311 of the impeller 300 and the inner edge 223 of the plurality of diffusor blades 205 of the diffusor 200.

It is understood that the height of the gap P1 and P2 as seen in the longitudinal direction depends on if it is measured between an outer edge 321; 323 of a vane 320; 322 and the envelope surface 305; 309 of the funnel shaped outlet 209; 217 or between the envelope surface 305; 309 of the first and second sections of the impeller 300 and the envelope surface of the funnel shaped outlet 209; 217. Also, it is to be understood that the height of the gaps P1 and P2 must not be uniform as seen in the radial direction. The height may advantageously gradually decrease in a radially outward direction.

As the two flows of slurry enter the gap G it will meet the gas flow which is emitted in the radial direction via the plurality of gas outlets 315. Simulations studying the interaction between the slurry and the gas in this area reveals something that can be seen as a three-layered sandwich structure with a first layer of slurry, an intermediate gas layer and a second layer of slurry. As the slurry and gas mixture continues in the radial direction it will be forced between the radially extending gaps 206 that are formed between the plurality of diffusor blades 205. Since the impeller 300 rotates with high speed in view of the stationary diffusor 200, the three-layered sandwich structure will be broken and the slurry and gas will be subjected to a very effective continuous intermixing where any agglomerates will break up into smaller fractions and in the best case into individual particles, while at the same time the gas flow will be beaten into bubbles to which the particles of valuable mineral may adhere. As the circulation continues, a froth containing gas bubbles and valuable minerals will be formed, and over time the froth will reach a density that is sufficient low for it to raise towards the top end of the flotation tank from where it may be removed. As this continuous rotation goes on, the amount of valuable mineral in the slurry will reduce over time. As the remaining amount has reached a target level, the rotation of the impeller is stopped and the remining dust will sink to the bottom of the flotation tank from where it may be removed for further processing.

Accordingly, and in summary, an arrangement is provided which uses an improved impeller and diffusor respective. The impeller is designed to generate two vortexes which act in two opposite axial directions, whereby the slurry can be pumped into a diffusor from two opposing directions. To account for this bi-directional pumping action, a diffusor is provided with two opposing funnel-shaped inlet mouths. Not only are the two inlet mouths funnel shaped, but also the respective funnel outlets into the middle section of the diffusor where the substantial part of the impeller is arranged. Further, in each of the opposing ends of the diffusor, the envelope surface of the funnel portion that forms the inlet and the envelope surface of the funnel portion that forms the outlet merge along a waist portion which has a radius r1; r2 that is smaller than the inner radius R of the diffusor blades. The inventive diffusor is thereby designed to guide the incoming bi-directional flow of slurry in the axial direction and then redirect the bi-directional flow into one uniform flow in the radial direction with a reduced loss of energy. The slurry will thereby meet the gas flow with a higher energy and also meet the diffusor blades with a higher energy, which has shown to result in a more efficient breaking-up of agglomerates into smaller fractions and a more efficient froth formation by beating the gas flow into bubbles which may adhere to particles of valuable mineral.

The skilled person realizes that a number of modifications of the embodiments described herein are possible without departing from the scope of the disclosure, which is defined in the appended claims.

For instance, the impeller and diffusor respectively may be designed in a number of ways within the scope of the claims.

The profile and extension of the vanes of the impeller may be varied in a number of ways. Although the vanes have been illustrated as having a generally straight radial extension, they may by way of example have a helical or curved extension. Also the number of vanes may be varied.

The diffusor blades have been disclosed as having a straight extension as seen in the longitudinal and the radial extension in view of the longitudinal center line. The skilled person realizes that the diffusor blades may be arranges in a number of ways and with different geometries. They may by way of example form a net-like structure or exhibit a honeycomb structure.

The impeller and the diffusor respectively may be formed by casting and/or machining or even by additive manufacturing.

The embodiments may alternatively be defined as follows:

Embodiment 1: An impeller (300) for mixing a gas and a slurry in a flotation tank, the impeller (300) comprising:

a first section (302) having a first inlet end (303) and a first outlet end (304) interconnected by a first envelope surface (305);

a second section (306) having a second inlet end (307) and a second outlet end (308) interconnected by a second envelope surface (309); and

a middle section (311) having a first end (310) and a second end (312); the first and second ends (310, 312) being interconnected by a side wall (314) extending along a rotation axis RA of the impeller (300); wherein

the first outlet end (304) of the first section (302) is connected to the first end (310) of the middle section (311), and the second outlet end (308) of the second section (306) is connected to the second end (312) of the middle section (311); and wherein

the side wall (314) of the middle section (311) comprises at least one gas outlet (315) configured to communicate with a gas supply GS.

Embodiment 2: The impeller (300) according to embodiment 1, wherein the first and/or the second envelope surface (305; 309) has a concave shape as seen in view of the rotation axis RA of the impeller (300).

Embodiment 3: The impeller (300) according to embodiment 1 or 2, wherein the first envelope surface (305) comprises a plurality of vanes (320) having an extension in a direction between the first inlet end (303) and the first outlet end (304); and/or

the second envelope surface (309) comprises a plurality of vanes (322) having an extension in a direction between the second inlet end (307) and the second outlet end (308).

Embodiment 4: The impeller (300) according to embodiment 3, wherein the vanes (320) of the first envelope surface (305) have an outer edge (321) facing away from the first envelope surface (305), said outer edge (321) having a concave shape as seen in view of the rotation axis RA of the impeller (300); and/or

wherein the vanes (322) of the second envelope surface (309) have an outer edge (323) facing away from the second envelope surface (309), said outer edge (323) having a concave shape as seen in view of the rotation axis RA of the impeller (300).

Embodiment 5: The impeller (300) according to embodiment 3 or 4, wherein the vanes (322) of the second envelope surface (309) have an inner edge (324) facing the rotation axis RA of the impeller (300), and an outer edge (323) facing away from the rotation axis RA of the impeller (300), wherein the inner and outer edges (323, 324) merges in a tip (325), wherein said tip (325) is radially displaced in view of the rotation axis RA of the impeller (300).

Embodiment 6: The impeller (300) according to any of embodiments 3-5, wherein a vane (320) in the first section and a vane (322) in the second section form a pair (327) of vanes, and wherein radially outer edges (328, 329) of the vanes in each pair (327) together with the side wall (314) of the middle section (311) have an extension substantially in parallel with the rotation axis RA of the impeller (300).

Embodiment 7: The impeller (300) according to any of the preceding embodiments, wherein the middle section (311′) further comprises a circumferentially extending groove (350′) communicating with the at least one gas outlet (315′).

Embodiment 8: The impeller (300) according to embodiment 7, wherein the groove (350′) comprises a plurality of radially extending fins (351′).

Embodiment 9: The impeller (300) according to embodiment 8, wherein the plurality of fins (351′) have an extension in the radial direction of the groove (350′) which is smaller than a radial depth of the groove (350′), and wherein the plurality of fins (351′) have an outer edge portion (352′) which is aligned with the side wall (214′) of the middle section (311′).

Embodiment 10: A diffusor (200) for mixing a gas and a slurry in a flotation tank, the diffusor comprising:

a first annular section (202);

a second annular section (203); and

a middle section (204) comprising a plurality diffusor blades (205) extending along a longitudinal center line L of the diffusor (200), and wherein the first annular section (202) and the second annular section (203) are connected on opposite sides of the middle section (204) as seen along the longitudinal center line L of the diffusor (200), wherein

the first annular section (202) comprises a funnel shaped inlet end (207) forming a first inlet mouth (208) of the diffusor (200); and

the second annular section (203) comprises a funnel shaped inlet end (215) forming a second inlet mouth (216) of the diffusor (200).

Embodiment 11: The diffusor (200) according to embodiment 10, wherein the first annular section (202) further comprises a funnel shaped outlet end (209), and wherein a narrow end (210) of the funnel shaped inlet end (207) merges with a narrow end (211) of the funnel shaped outlet end (209), and the middle section (204) interconnects with a wide end (212) of the funnel shaped outlet end (209); and

the second annular section (203) further comprises a funnel shaped outlet end (217), and wherein a narrow end (218) of the funnel shaped inlet end (215) merges with a narrow end (219) of the funnel shaped outlet end (217), and the middle section (204) interconnects with a wide end (220) of the funnel shaped outlet end (217).

Embodiment 12: The diffusor (200) according to embodiment 10 or 11, wherein the funnel shaped inlet and outlet ends (207, 209; 215, 217) of the first and second annular sections (203, 204) each have a convex envelope surface (213, 214; 221, 222) as seen in view of the longitudinal center line L of the diffusor (200).

Embodiment 13: The diffusor (200) according to embodiment 10 or 11, wherein the first and second inlet mouths (208, 216) each have a radius r1; r2 being smaller than an inner most radius R of the plurality of diffusor blades (205).

Embodiment 14: The diffusor (200) according to embodiment 10 or 11, wherein the second annular section (203) and the middle section (24) each has a length L2; L3 along the longitudinal center line L of the diffusor (200), and wherein the length L3 of the second annular section L3 exceeds or corresponds to the length L2 of the middle section (204).

Embodiment 15: The diffusor (200) according to embodiment 10 or 11, wherein the first annular section (202) and the middle section (204) each has a length L1; L2 along the longitudinal center line L of the diffusor (200), and wherein the length L1 of the first annular section (202) is smaller than the length L2 of the middle section (204).

Embodiment 16: The diffusor (200) according to any of embodiments 10-15, wherein the first annular section (202) and the second annular section (203) each has a length L1; L2 along the longitudinal center line L of the diffusor (200), and wherein the length L1 of the first annular section (202) is smaller than the length L3 of the second annular section (203).

Embodiment 17: The diffusor (200) according to any of embodiments 10-16, wherein the radius r2 of the second inlet mouth (216) of the diffusor (200) is smaller than the radius r1 of the first inlet mouth (208) of the diffusor (200).

Embodiment 18: Arrangement (1000) for the use in a flotation tank to enhance mixing of gas and slurry, the apparatus comprising an impeller (300) according to any of embodiments 1-9 and a diffusor (200) according to any of embodiments 10-17, wherein the impeller (300) is configured to be rotatably and coaxially received inside the diffusor (200).

Embodiment 19: The arrangement (1000) according to embodiment 18, wherein the outer edge of the vanes (320) on the first section of the impeller (300) have a shape being substantially complementary to a portion of the funnel shaped outlet end of the first annular section of the diffusor (200); and/or wherein

the outer edge of the vanes (322) on the second section of the impeller (300) have

a shape being substantially complementary to a portion of the funnel shaped outlet end of the second annular section of the diffusor (200).

Embodiment 20: The arrangement (1000) according to embodiment 18 or 19, wherein a radially extending gap G is formed between the side wall of the middle section of the impeller (300) and the plurality of diffusor blades (205) of the diffusor (200).

Embodiment 21: Use of an arrangement (1000) according to any of embodiment 18-20 in a flotation tank (100) to enhance mixing of gas and slurry.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. An impeller for mixing a gas and a slurry in a flotation tank, the impeller comprising:
a first section having a first inlet end and a first outlet end interconnected by a first envelope surface;
a second section having a second inlet end and a second outlet end interconnected by a second envelope surface; and
a middle section having a first end and a second end; the first and second ends being interconnected by a side wall extending along a rotation axis of the impeller; wherein
the first outlet end of the first section is connected to the first end of the middle section, and the second outlet end of the second section is connected to the second end of the middle section; and wherein
the side wall of the middle section comprises at least one gas outlet configured to communicate with a gas supply.

2. The impeller according to claim 1, wherein the first and/or the second envelope surface has a concave shape as seen in view of the rotation axis of the impeller.

3. The impeller according to claim 1, wherein the first envelope surface comprises a plurality of vanes having an extension in a direction between the first inlet end and the first outlet end; and/or
the second envelope surface comprises a plurality of vanes having an extension in a direction between the second inlet end and the second outlet end.

4. The impeller according to claim 3, wherein the vanes of the first envelope surface have an outer edge facing away from the first envelope surface, said outer edge having a concave shape as seen in view of the rotation axis of the impeller; and/or
wherein the vanes of the second envelope surface have an outer edge facing away from the second envelope surface, said outer edge having a concave shape as seen in view of the rotation axis of the impeller.

5. The impeller according to claim 3, wherein the vanes of the second envelope surface have an inner edge facing the rotation axis of the impeller, and an outer edge facing away from the rotation axis of the impeller, wherein the inner and outer edges merges in a tip, wherein said tip is radially displaced in view of the rotation axis of the impeller.

6. The impeller according to claim 3, wherein a vane in the first section and a vane in the second section form a pair of vanes, and wherein radially outer edges of the vanes in each pair together with the side wall of the middle section have an extension substantially in parallel with the rotation axis of the impeller.

7. The impeller according to claim 1, wherein the middle section further comprises a circumferentially extending groove communicating with the at least one gas outlet.

8. The impeller according to claim 7, wherein the groove comprises a plurality of radially extending fins; and/or wherein the plurality of fins have an extension in the radial direction of the groove which is smaller than a radial depth of the groove, and wherein the plurality of fins have an outer edge portion which is aligned with the side wall of the middle section.

9. A diffusor for mixing a gas and a slurry in a flotation tank, the diffusor comprising:
a first annular section;
a second annular section; and
a middle section comprising a plurality diffusor blades extending along a longitudinal center line of the diffusor, and wherein the first annular section and the second annular section are connected on opposite sides of the middle section as seen along the longitudinal center line of the diffusor; wherein
the first annular section comprises a funnel shaped inlet end forming a first inlet mouth of the diffusor; and
the second annular section comprises a funnel shaped inlet end forming a second inlet mouth of the diffusor.

10. The diffusor according to claim 9, wherein the first annular section further comprises a funnel shaped outlet end, and wherein a narrow end of the funnel shaped inlet end merges with a narrow end of the funnel shaped outlet end, and the middle section interconnects with a wide end of the funnel shaped outlet end; and
the second annular section further comprises a funnel shaped outlet end, and wherein a narrow end of the funnel shaped inlet end merges with a narrow end of the funnel shaped outlet end, and the middle section interconnects with a wide end of the funnel shaped outlet end.

11. The diffusor according to claim 9, wherein the funnel shaped inlet and outlet ends of the first and second annular sections each have a convex envelope surface as seen in view of the longitudinal center line of the diffusor.

12. The diffusor according to claim 9, wherein the first and second inlet mouths each have a radius being smaller than an inner most radius of the plurality of diffusor blades.

13. The diffusor according to claim 9, wherein the second annular section and the middle section each has a length along the longitudinal center line of the diffusor, and wherein the length of the second annular section exceeds or corresponds to the length of the middle section.

14. The diffusor according to claim 9, wherein the first annular section and the middle section each has a length along the longitudinal center line of the diffusor, and wherein the length of the first annular section is smaller than the length of the middle section.

15. The diffusor according to claim 9, wherein the first annular section and the second annular section each has a length along the longitudinal center line of the diffusor, and wherein the length of the first annular section is smaller than the length of the second annular section.

16. The diffusor according to claims 9, wherein the radius of the second inlet mouth of the diffusor is smaller than the radius of the first inlet mouth of the diffusor.

17. Arrangement for the use in a flotation tank to enhance mixing of gas and slurry, the apparatus comprising an impeller according to claim 1 and a diffusor according to claim 9, wherein the impeller is configured to be rotatably and coaxially received inside the diffusor.

18. The arrangement according to claim 17, wherein the outer edge of the vanes on the first section of the impeller have a shape being substantially complementary to a portion of the funnel shaped outlet end of the first annular section of the diffusor; and/or wherein
the outer edge of the vanes on the second section of the impeller have a shape being substantially complementary to a portion of the funnel shaped outlet end of the second annular section of the diffusor.

19. The arrangement according to claim 17, wherein a radially extending gap is formed between the side wall of the middle section of the impeller and the plurality of diffusor blades of the diffusor.

20. Use of an arrangement according to claim 17 in a flotation tank to enhance mixing of gas and slurry.
